(19) United States
(12) Patent Application Publication
(10) Pub. No.: US 2006/0000109 A1
(43) Pub. Date: Jan. 5, 2006

(54) Method and apparatus for reducing spin-induced wafer charging

(75) Inventors: Hua-Tai Lin, Yung-Kang City (TW); Shih-Che Wang, Hsin-Chu City (TW); Louie Liu, Hsin-Chu (TW); Chi-Hung Liao, Sanchong City (TW); Yi-Ming Dai, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/884,714

(22) Filed: Jul. 3, 2004

(51) Int. Cl. C23G 1/02; F26B 5/08; F26B 17/24

(52) U.S. Cl. 34/312; 134/33; 134/2; 34/58

(57) ABSTRACT

A novel method and apparatus for reducing or eliminating electrostatic charging of wafers during a spin-dry step of wafer cleaning is disclosed. The method includes rinsing a wafer, typically by dispensing a cleaning liquid such as deionized water on the wafer while spinning the wafer; and spin-drying the wafer by sequentially rotating the wafer in opposite directions. The apparatus includes a wafer support platform that is capable of sequentially rotating a wafer in opposite directions to spin-dry the wafer.

### FIELD OF THE INVENTION

The present invention relates to methods for drying wafers during the fabrication of semiconductor integrated circuits on the wafers. More particularly, the present invention relates to a method and apparatus for reducing wafer charging during spin-drying of a wafer.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

Since the processing of silicon wafers requires extreme cleanliness in the processing environment to minimize the presence of contaminating particles or films, the surface of the silicon wafer is frequently cleaned after each processing step. For instance, the wafer surface is cleaned after the deposition of a surface coating layer such as oxide or after the formation of a circuit by a processing step such as etching. A frequently-used method for cleaning the wafer surface is a wet scrubbing method.

In an SRD cleaning process, a wafer is normally positioned on a wafer platform which is typically rotatably mounted on a wafer stage. The wafer platform rotates the wafer at a predetermined rotational speed, which may be between typically about 30 RPM and about 5,000 RPM. Simultaneously, a water jet of de-ionized water is ejected onto the upper surface of the rotating wafer from a nozzle opening in the nozzle.

As it strikes the surface of the wafer, the water jet is typically scanned along a top of the wafer surface by a lateral sweeping motion of the water jet nozzle to define a generally curved or arcuate trace which normally traverses the center of the wafer. The surface of the wafer is scanned by the water jet at least once, and preferably, several times. Centrifugal force acting on the water flow on the surface of the wafer due to the rotating wafer platform and wafer removes contaminating particles or films from the surface of the wafer. Horizontal movement of the wafer stage beneath the water jet nozzle during the scrubbing process provides a more uniform dispersement of the sprayed water along the entire surface of the disc. After completion of the jet-scrubbing process, the wafer is subjected to a spin-drying step in which the wafer is rotated and nitrogen or clean dry air (CDA) is blown against the wafer surface.

FIG. 1 illustrates a silicon wafer 10 the upper surface of which is sprayed in an SRD (spin-rinse-dry) waterjet scrubbing method using a conventional wafer scrubbing apparatus 8. The wafer 10 is normally positioned on a wafer platform 12 which is supported by a shaft 14. The shaft 14 is engaged by a motor 16 for rotation. The wafer platform 12 rotates the wafer 10 at a predetermined rotational speed, which may be between about 30 RPM and about 5,000 RPM. A water jet 18 of deionized water is ejected from a water jet nozzle 20 positioned above the surface of the wafer 10. The water jet 18 has a water pressure of typically about 50 kg/cm². As it strikes the surface of the wafer 10, the water jet 18 may be scanned along a top of the wafer surface by a lateral sweeping motion of the water jet nozzle 20 to define a generally curved or arcuate trace which normally traverses the center of the wafer 10. The surface of the wafer 10 is scanned by the water jet 18 at least once, and preferably, several times. Centrifugal force acting on the water flow on the surface of the wafer 10 due to the rotating wafer platform 12 and wafer 10 removes contaminating particles or films from the surface of the wafer 10.

After the rinsing step is completed, the wafer 10 is subjected an SRD drying step. Accordingly, the wafer 10 remains on the wafer platform 12. The motor 16 rotates the shaft 14 and wafer platform 12 in one direction, as indicated by the curved arrows, at rotational speeds of up to 4,000 rpm. This evaporates the residual rinsing water from the surface of the wafer 10.

One of the limitations of the SRD drying step is that rotation of the wafer frequently results in electrostatic charging of the wafer surface. The presence of electrostatic charges on the surface of the wafer increases particle contamination of the wafer surface. This ultimately leads to defect densities in the finished chips or die fabricated on the wafer, as revealed by chip testing. Furthermore, electrostatic charges on the surface of the wafer frequently interfere with the operation of production equipment, thus decreasing up-time, interrupting process flow or requiring re-processing of the semiconductor products. The problems caused by electrostatic charges tend to be more of a problem in photolithography areas than in other areas of semiconductor production. Accordingly, a method and apparatus for reducing or eliminating wafer charging during spin-rinse-drying of wafers is needed.

An object of the present invention is to provide a novel method for reducing electrostatic charging of wafers during a spin-drying process.

Another object of the present invention is to provide a novel wafer charging reduction method which is effective in reducing defects in integrated circuit devices formed on a wafer.

Still another object of the present invention is to provide a novel method for reducing electrostatic charging of a wafer during a spin-drying process by sequentially rotating the wafer in the clockwise and counterclockwise directions, respectively, or in the counterclockwise and clockwise directions, respectively.

A still further object of the present invention is to provide a novel method for reducing electrostatic charging of a wafer during a spin-drying process, which method is effective in removing a rinsing liquid from high aspect ratio trenches and other openings in devices fabricated on the wafer.

Yet another object of the present invention is to provide a novel apparatus for reducing electrostatic charging of wafers, which apparatus includes an SRD (spin-rinse-dry) apparatus that is capable of sequentially rotating a wafer in opposite directions during spin-drying of the wafer.

### SUMMARY OF THE INVENTION

In accordance with these and other objects and advantages, the present invention is generally directed to a novel method for reducing or eliminating electrostatic charging of wafers during a spin-dry step of wafer cleaning. The method includes rinsing a wafer, typically by dispensing a cleaning liquid such as deionized water on the wafer while spinning the wafer; and spin-drying the wafer by sequentially rotating the wafer in opposite directions. This reduces the accumulation of electrostatic charges on the wafer as compared to unidirectional rotation of the wafer during the spin-drying step. Furthermore, the method is effective in removing the deionized water or other rinsing liquid from high aspect ratio trenches and other openings in devices fabricated on the wafer.

The present invention is further directed to a novel apparatus for reducing electrostatic charging of wafers during a spin-drying process. The apparatus includes an SRD (spin-rinse-dry) apparatus that is capable of sequentially rotating a wafer in opposite directions during spin-drying of the wafer.

### BRIEF DESCRIPTION OF THE DRAWINGS

The invention will now be described, by way of example, with reference to the accompanying drawings, in which:

FIG. 1 is a schematic of a typical conventional spin-rinse dryer, illustrating spin-rinsing of a wafer, followed by spin-drying of the wafer;

FIG. 2 is a schematic of an illustrative embodiment of a spin-rinse dryer according to the present invention, illustrating spin-rinsing of a wafer, followed by spin-drying of the wafer according to the method of the present invention; and

FIG. 3 is a flow diagram which summarizes sequential process steps carried out according to the method of the present invention.

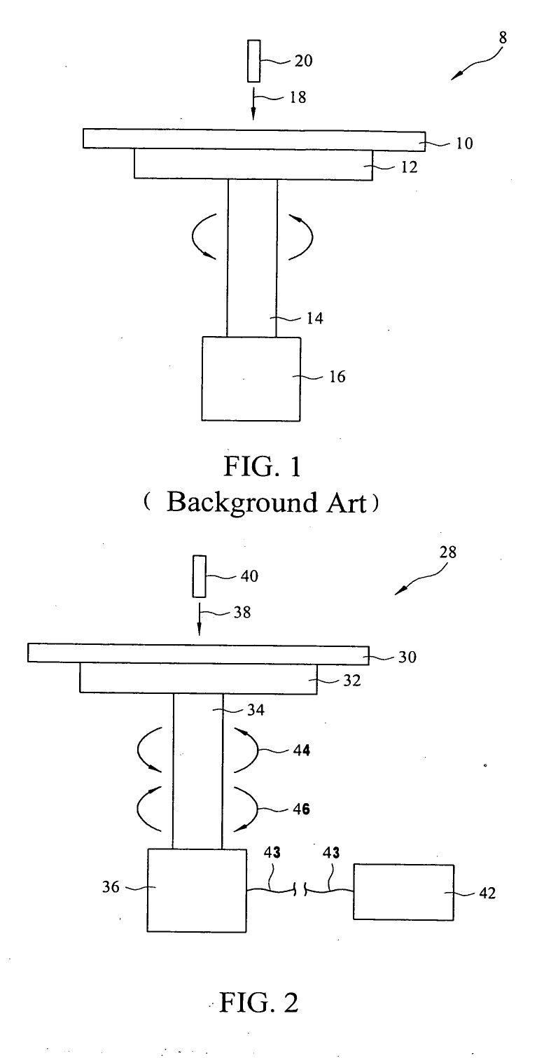

### DETAILED DESCRIPTION OF THE INVENTION

The present invention is generally directed to a novel method which is effective in eliminating or at least reducing spin-induced electrostatic charging of semiconductor wafers during a spin-drying step of wafer cleaning carried out at various points during the fabrication of integrated circuits (ICs) on the wafers. According to the method, a wafer is rinsed following an IC device fabrication step, typically by dispensing deionized water or other cleaning liquid on the wafer as the wafer is rotated. The wafer is then subjected to a multi-stage spin-drying step in which the wafer is sequentially rotated in opposite directions. This bi-directional rotation of the wafer reduces the accumulation of electrostatic charges on the wafer as the wafer is dried. Furthermore, bi-directional rotation of the wafer during the spin-drying step is effective in removing the deionized water or other cleaning liquid from high aspect ratio trenches and other openings in devices fabricated on the wafer.

The present invention is further directed to a novel apparatus for reducing electrostatic charging of wafers during a spin-drying process. The apparatus includes an SRD (spin-rinse-dry) apparatus that is capable of sequentially rotating a wafer in opposite directions during spin-drying of the wafer. The SRD apparatus includes an electric motor and a controller which is operably connected to the motor for selective rotation of the motor in a clockwise or counterclockwise direction at a selected rotational speed.

Referring to FIG. 2, an illustrative embodiment of an SRD (spin-rinse-dry) wafer scrubbing apparatus according to the present invention is generally indicated by reference numeral 28. The SRD wafer scrubbing apparatus 28 includes an electric motor 36. The lower end of a shaft 34 is engaged by the electric motor 36 for rotation thereby. A wafer platform 32, which is adapted for supporting a wafer 30, is supported on the upper end of the shaft 34 for rotation by the shaft 34. A water jet nozzle 40 is positioned above the wafer platform 32 for ejecting a jet 38 of pressurized cleaning liquid, such as deionized water, onto the wafer 30 during a spin-rinsing step of wafer cleaning, which will be hereinafter described.

By use of techniques known to those skilled in the art, the controller 42 is operably connected to the motor 36, such as through suitable controller wiring 43, in such a manner as to facilitate rotation of the shaft 34 and wafer platform 32 in a selected counterclockwise or clockwise direction, as indicated by the curved counterclockwise arrow 44 and clockwise arrow 46, respectively. A speed controller dial or switch (not shown) may be provided on the controller 42 to facilitate manual selection between various rotational speeds of the wafer platform 32 as the motor 36 rotates the wafer platform 32 in the selected clockwise or counterclockwise direction. Alternatively, the controller 42 may include a microprocessor with supporting software which enables programmed operation of the motor 36. In that case, the controller 42 can be programmed to operate the motor 36 in such a manner that the wafer platform 32 is rotated at a selected rotational speed in one direction and then at a selected rotational speed in the opposite direction during the spin-drying process of wafer cleaning.

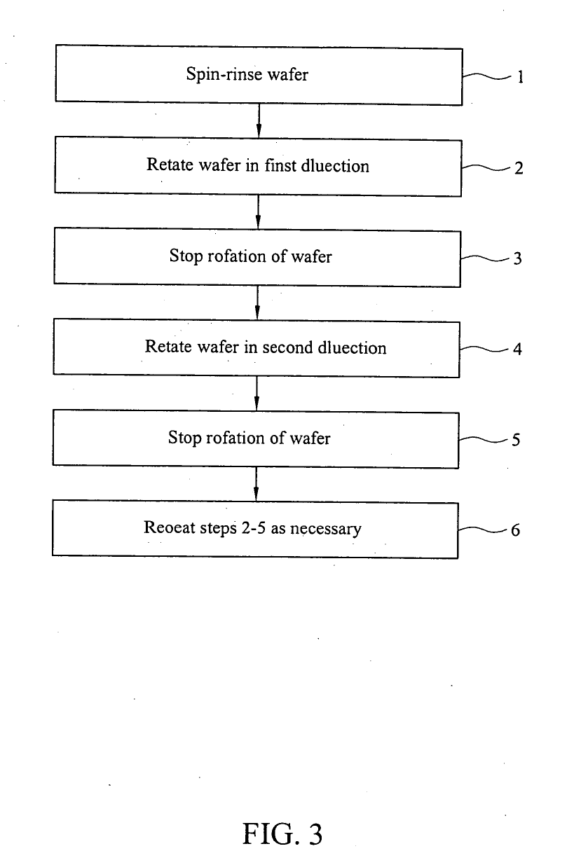

Referring again to FIG. 2, in conjunction with the flow diagram of FIG. 3, the method of the present invention is carried out typically as follows. First, the wafer 30 is placed on the wafer platform 32 for initial spin-rinsing of the wafer 30 in an SRD wafer cleaning process, as indicated in step 1 of FIG. 3. In the IC fabrication processes preceding the SRD cleaning process, various IC fabrication steps are carried out on the wafer 30. These may include a photolithography process, for example, in which a photoresist layer (not shown) is deposited on a conductive layer (not shown) on the wafer 30; the photoresist is exposed to ultraviolet light through a mask or reticle, wherein exposed portions of the photoresist are rendered either soluble or insoluble in a developing chemical; and the photoresist is developed, wherein the photoresist is exposed to the developing chemical to remove the soluble portions of the photoresist from the wafer. After the development step of photolithography, the SRD spin-rinsing step 1 may be carried out to remove residual photoresist particles from the wafer prior to further processing. However, it is understood that the SRD spin-rinsing step 1 may be carried out at any point during processing, as deemed necessary for the removal of particulate contaminants from the wafer.

During the SRD spin-rinsing step 1, a jet of pressurized cleaning liquid 38, such as deionized (DI) water, is ejected from the dispensing nozzle 40 and onto the wafer 30. Simultaneously, the wafer platform 32 rotates the wafer 30 at a predetermined rotational speed, which may be between typically about 30 RPM and about 5,000 RPM. The cleaning liquid 38 typically strikes the center of the rotating wafer 30 and is drawn outwardly by centrifugal force toward the edge of the wafer 30, washing particles from the wafer 30. The SRD spin-rinsing step 1 may be carried out using process parameters which are known to those skilled in the art.

Upon completion of the SRD spin-rinsing step 1, the wafer 30 is subjected to a spin-drying process according to the method of the present invention. Accordingly, as indicated in step 2 of FIG. 3, the wafer 30 is initially rotated in a first direction, such as a counterclockwise direction, as indicated by the counterclockwise arrow 44 of FIG. 2. Preferably, the wafer 30 is rotated in the first direction at a gradually-increasing rotational speed until the wafer 30 reaches a target rotational speed of typically about 20˜5,000 rpm for a period of typically about 1˜60 sec.

Next, as indicated in step 3, rotation of the wafer 30 is gradually stopped. As indicated in step 4, the wafer 30 is then rotated in the second direction. The second direction of wafer rotation is the clockwise direction as indicated by the clockwise arrow 46 (in the event that the first direction was the counterclockwise direction) or the counterclockwise direction as indicated by the counterclockwise arrow 44 (in the event that the first direction was the clockwise direction). Preferably, the wafer 30 is rotated in the second direction at a gradually-increasing rotational speed until the wafer 30 reaches a target rotational speed of typically about 300˜5,000 rpm for a period of typically about 1˜60 sec.

As indicated in step 5, rotation of the wafer 30 is then stopped. As indicated in step 6, steps 1-5 or 2-5 may then be repeated, as necessary, to complete drying of the wafer 30. It will be appreciated by those skilled in the art that sequential rotation of the wafer 30 in the clockwise and counterclockwise directions in alternating order prevents or minimizes the accumulation of electrostatic charges on the wafer 30 which otherwise tends to attract potential device-contaminating particles to the wafer 30 during spin-drying. This reduces the number of defects and enhances the yield of devices on the wafer 30.

While the preferred embodiments of the invention have been described above, it will be recognized and understood that various modifications can be made in the invention and the appended claims are intended to cover all such modifications which may fall within the spirit and scope of the invention.

What is claimed is:

1. A method of reducing electrostatic charging of a wafer, comprising:
rinsing said wafer; and
drying said wafer by rotating said wafer in a first direction and rotating said wafer in a second direction.

2. The method of claim 1 wherein said rotating said wafer in a first direction comprises rotating said wafer in a counterclockwise direction and said rotating said wafer in a second direction comprises rotating said wafer in a clockwise direction.

3. The method of claim 1 wherein said rotating said wafer in a first direction and said rotating said wafer in a second direction comprises rotating said wafer at a rotational speed of from about 30 to about 5,000.

4. The method of claim 3 wherein said rotating said wafer in a first direction comprises rotating said wafer in a counterclockwise direction and said rotating said wafer in a second direction comprises rotating said wafer in a clockwise direction.

5. The method of claim 1 wherein said rotating said wafer in a first direction comprises rotating said wafer in a clockwise direction and said rotating said wafer in a second direction comprises rotating said wafer in a counterclockwise direction.

6. The method of claim 5 wherein said rotating said wafer in a first direction and said rotating said wafer in a second direction comprises rotating said wafer at a rotational speed of from about 30 to about 5,000.

7. The method of claim 1 wherein said rinsing said wafer comprises providing a cleaning liquid, rotating said wafer and spraying said cleaning liquid against said wafer.

8. The method of claim 7 wherein said rotating said wafer in a first direction comprises rotating said wafer in a counterclockwise direction and said rotating said wafer in a second direction comprises rotating said wafer in a clockwise direction.

9. The method of claim 7 wherein said rotating said wafer in a first direction and said rotating said wafer in a second direction comprises rotating said wafer at a rotational speed of from about 300 to about 5,000.

10. The method of claim 9 wherein said rotating said wafer in a first direction comprises rotating said wafer in a counterclockwise direction and said rotating said wafer in a second direction comprises rotating said wafer in a clockwise direction.

11. The method of claim 7 wherein said rotating said wafer in a first direction comprises rotating said wafer in a clockwise direction and said rotating said wafer in a second direction comprises rotating said wafer in a counterclockwise direction.

12. The method of claim 11 wherein said rotating said wafer in a first direction and said rotating said wafer in a second direction comprises rotating said wafer at a rotational speed of from about 200 to about 4,000.

13. A method of reducing electrostatic charging of a wafer, comprising:
rinsing said wafer; and
drying said wafer by rotating said wafer in opposite directions in alternating order.

14. The method of claim 13 wherein said rotating said wafer in opposite directions in alternating order comprises rotating said wafer in a counterclockwise direction and rotating said wafer in a clockwise direction, respectively.

15. The method of claim 13 wherein said rotating said wafer in opposite directions in alternating order comprises rotating said wafer at a rotational speed of from about 30 to about 5,000.

16. The method of claim 15 wherein said rotating said wafer in opposite directions in alternating order comprises rotating said wafer in a counterclockwise direction and rotating said wafer in a clockwise direction, respectively.

17. The method of claim 13 wherein said rotating said wafer in opposite directions in alternating order comprises rotating said wafer in a clockwise direction and rotating said wafer in a counterclockwise direction, respectively.

18. The method of claim 17 wherein said rotating said wafer in opposite directions in alternating order comprises rotating said wafer at a rotational speed of from about 200 to about 4,000.

19. An apparatus for spin-drying a wafer while preventing accumulation of electrostatic charges on the wafer, comprising:
a wafer platform for supporting the wafer; and
a motor operably connected to said wafer platform, said motor operable to selectively rotate said wafer platform in a counterclockwise direction and a clockwise direction.

20. The apparatus of claim 19 further comprising a controller operably connected to said motor for controlling rotation of said wafer platform.
